(19) United States
(12) Patent Application Publication
(10) Pub. No.: US 2007/0257156 A1
(43) Pub. Date: Nov. 8, 2007

(54) Gutter Manifold Clip

(75) Inventors: Raymond Keith Lunt, Queensland (AU); Adrian Van Wyk, Queensland (AU)

Correspondence Address: BROOKS KUSHMAN P.C., 1000 TOWN CENTER, TWENTY-SECOND FLOOR, SOUTHFIELD, MI, 48075, US

(73) Assignee: RAYSIT HOLDINGS PTY LTD, Brisbane, QLD (AU)

(21) Appl. No.: 11/573,136

(22) PCT Filed: Jul. 28, 2005
(86) PCT No.: PCT/AU05/01104

§ 371 Date: Feb. 2, 2007

(30) Foreign Application Priority Data
Aug. 2, 2004 (AU) 2004904279

(51) Int. Cl. F16L 3/00

(52) U.S. Cl. 248/49

(57) ABSTRACT

A guttering manifold clip (1, 3, 4, 5) for fixing a fluid distribution pipe (9) within the upper outer inside lip (6) of the gutters. The clip is designed to clip into existing and common gutters of roofed structures. The purpose of the pipe (9) is to provide a water source for the provision of sprinklers on the inside of the gutter for the purpose of resisting burning of a house/buildings etc due to bush fire.

A clip designed to be fitted within a guttering system of a roofed structure. The clip is designed to carry/saddle piping/conduit for the purposes of distributing fluid in the aid of wild/bush fire protection of an establishment. The clip is versatile and adjustable in that it may be fitted to most common types of external guttering systems.

### BACKGROUND OF THE INVENTION

The Gutter manifold clip apparatus is designed to satisfy an identified need to fasten a sprinkler system onto the internal side of a gutter section on a roofed structure. The current methods of attaching such fire prevention type systems require the drilling of holes into one or more of the following, the roofing, the upright walls, the guttering or guttering support. The drilling of such holes present dangers, such as, the piercing of concealed electrical cables, puncturing such pressurized water/gas lines or causing a weakening of materials, as in framing, roofing or guttering. These methods will further more require foreknowledge on the internals of a structure i.e. a builder or qualified trades person of whom would need to have studied detailed plans of an identified structure before carrying out such works. A home handyman or lay trades person without such knowledge risks injury to themselves, others or possible costly damages to a structure.

### OBJECT OF THE INVENTION

It is an object of the invention to alleviate one or more of the risks stated above, associated with the installation of such fire prevention type systems. It is also an object of the invention to simplify type applications for i.e. builders or trades people and provide a means for the handyman and common home owner alike.

### ADVANTAGES OF THE INVENTION

The Gutter Manifold Clip provides a simple yet effective means to attach a fire prevention type system or otherwise into a guttering section of a dwelling or structure without having to drill any specific holes.
The clip offers an economical method of installing such a system.
The clip can be made of a number of fire resistant materials.
The clip also offers an aesthetically pleasing solution to the installation of piping/cabling within an externally mounted gutter system.

### INVENTION DESCRIPTION

The Gutter Manifold Clip is designed to clip into existing and common gutters of roofed structures. The clip is attached within the upper outer lip of many such gutter profiles in production and known in the art. The said clip is designed to be placed at intervals along any given length of guttering, depending on rigidity of piping/manifold used for the purposes of distributing fluid or otherwise. The clip is manually pressed into position within the said gutter upper outer lip, being either supported by its neck or adjustable arms. With the clip in position, any piping/manifold required may be laid across the saddle and fastened into place with the malleable/bendable tale of the clip folded/pressed down over the subject, thus the Gutter manifold clip's duty is performed.

### DRAWING DESCRIPTION

FIG. 1pg 2 is a 3 dimensional view of the clip with adjustable arms at manufacture.

FIG. 2pg 2 is as drawing 1 with the adjustable arms in practice.
Pt1 refers to the head of the clip. Pt2 refers to the adjustable arms. Pt3 refers to the supporting neck. Pt4 refers to the saddle. Pt5 refers to the tail.

FIG. 3pg 3 is a cut section of the clip in place in a standard type quad gutter.

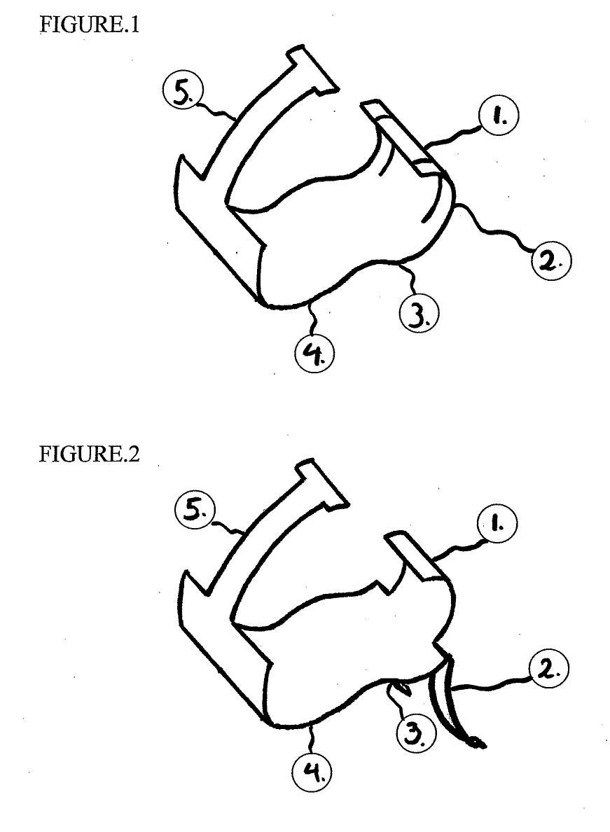

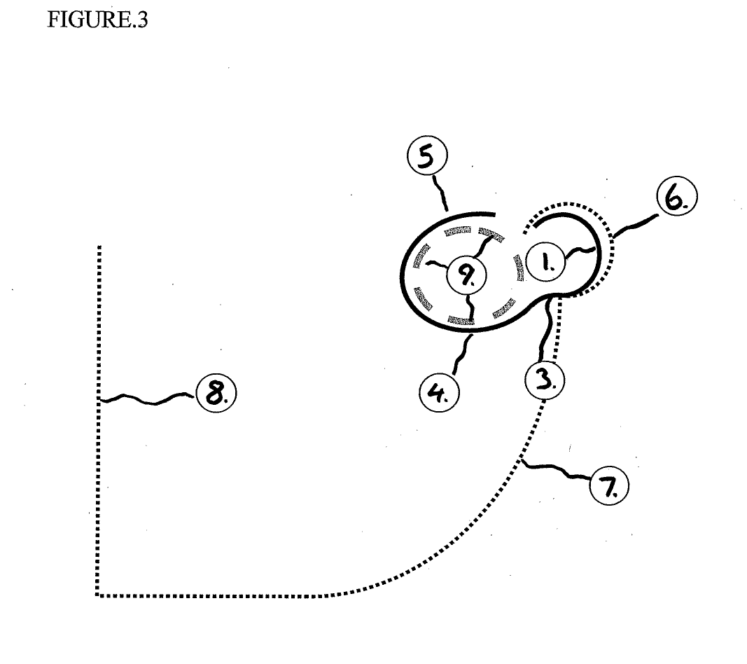

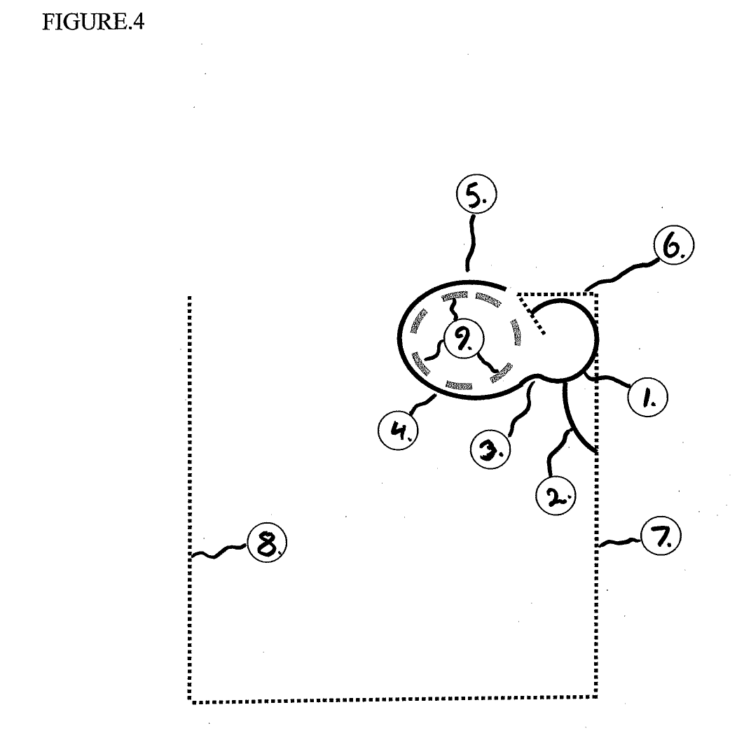

FIG. 4pg 4 is a cut section of the clip in place in a standard type external box gutter. All pts referred to in FIGS. 1&2 are commonly identified with FIGS. 3&4 respectively
Pt6 refers to the gutter upper outer lip/groove/fold. Pt7 refers to the gutter front exposed wall. Pt8 refers to the rear gutter wall, attachable to a structure/fascia. Pt9 refers to possible manifold, piping, conduit/cabling.

1. The Guttering Manifold Clip is mountable to most common externally mounted gutter systems of roofed structures.

2. The guttering Manifold Clip is pressed in or self supported within the upper outer inside lip, groove or fold of the externally mounted gutter.

3. The Gutter Manifold Clip is equipped with two adjustable arms bendable from the Shoulder of the invention enabling it to be height adjustable within the gutter or supportive of itself depending on the gutter type in which it is fitted.

4. The Guttering Manifold Clip may be bent, twisted, contorted in any way necessary to conform and be used in any new type of, or yet to be tested guttering systems.

5. The Guttering Manifold Clip is mounted in such a way that it is not visible to persons viewing a gutter from a level equal to the bottom of the gutter or below.

6. The Guttering Manifold Clip may be used to support any suitably sized piping, conduit or cabling within a guttering system.

7. The clip at present measures from the Head to the base of the tail a length of approximately 42 mm. The width of the Clip measures at approx' 22 mm. The width of the Tail is measured at approx' 5 mm. The length of the tail measures at 30 mm. The width of the Arms measure at approx' 3-4 mm.

8. The measurements given in claim 7 are open to adjustment for the purpose of the Clip being redesigned to suit new and inventive gutters, yet retaining its basic form and function.

9. The Guttering manifold Clip may be constructed from any suitable fire resistant materials i.e. bronze, copper, steel, stainless or otherwise.
